(19) United States
(12) Patent Application Publication
(10) Pub. No.: US 2005/0180053 A1
(43) Pub. Date: Aug. 18, 2005

(54) Cross talk and EME minimizing suspension design

(75) Inventors: Moris Dovek, San Jose, CA (US); David Hu, Los Altos, CA (US)

Correspondence Address: STEPHEN B. ACKERMAN, 28 DAVIS AVENUE, POUGHKEEPSIE, NY, 12603, US

(73) Assignee: Headway Technologies, Inc.

(21) Appl. No.: 10/781,000

(22) Filed: Feb. 18, 2004

(51) Int. Cl. G11B 5/48

(52) U.S. Cl. 360/246

(57) ABSTRACT

This structure and method for minimizing EME (Electromagnetic Emission) and the crosstalk between the signal lines which are used to write and read the tracks of magnetic disk drives. These signal lines are located on magnetic trace suspension assemblies which move above the magnetic disk drives. The structure and method utilize well-placed single and multiple crossovers on either or both of the lines used to read and write the tracks on magnetic disks. In addition, the structure and method utilize the parasitic capacitances between the write and read lines to couple beneficial voltages which cancel the unwanted crosstalk noise.

### BACKGROUND OF THE INVENTION

1. Field of the Invention

The present invention generally relates to the general field of magnetic trace suspension assemblies for magnetic disk drives. More particularly, this invention relates to a structure and a method for minimizing the crosstalk between the signal lines which are used to write and read the tracks of magnetic disk drives, and Electromagnetic Emission (EME) from the drive.

2. Description of the Prior Art

FIG. 1 shows a prior art magnetic trace suspension assembly, with the slider 110 and the four trace 130 connecting the two read 140 lines and the two write lines 150. Prior art disk drives contain disk drive suspensions, which support magnetic heads. These read/write heads are held above information tracks, which are contained in rotating magnetic disks within the disk drives.

As the density of disk drives increases in each new generation of storage devices, the density of the information tracks on the magnetic disks increases. This is achieved by using narrower and more closely spaced tracks. These more closely spaced tracks complicate the design of the magnetic head suspensions, which are used to accurately & quickly position the read and write heads over the required information track on the magnetic disk. Microactuators are used to position the suspension assemblies. However, the voltage swing required to position the assemblies over the tracks are relatively large (about 30 volts) compared to the lower voltages (millivolts) used to control the sliding of the magnetic head on the assembly. The larger magnetized microactivator signals will capacitively couple into the magnetic head slider signals, which are located in close proximity to each other as shown in FIG. 1. This crosstalk coupling complicates the design of higher density disk drives (Includes summary of 3 prior art dockets here).

U.S. Pat. No. 6,256,172 (Griesbach) describes a head suspension having an active crosstalk attenuation conductor. The suspension is formed on a load beam for conducting a crosstalk attenuation signal in order to reduce crosstalk interference.

U.S. Pat. No. 6,008,719 (Jolivet) discloses an electrical control device with crosstalk correction. The device includes several devices each electrically controllable by a limiter resistor.

U.S. Pat. No. 5,195,003 (Nishimura, et al.) describes a crosstalk prevention means which is connected in parallel to an erasing coil for erasing part of data prior to recording the data by a read/write coil, whereby canceling magnetic flux for erasing a crosstalk magnetic flux is generated to improve the signal to noise ratio.

### SUMMARY OF THE INVENTION

It is therefore an object of the present invention to provide a structure and a method for minimizing the crosstalk and EME between the signal lines on a trace suspension assembly which are used to write and read the tracks of magnetic disk drives. It is further an object of this invention to provide alternative implementations of this structure and method in order to minimize the crosstalk and EME in various uses of the trace suspension assembly.

The objects of this invention are achieved by a crosstalk and EME minimizing trace suspension assembly structure comprising multiple write lines which are crossed between said preamplifier connection point and said slider contact pads, multiple read lines driven by pre-amplifier circuits, slider contact pads, which connect said write lines to said trace suspension assembly, slider contact pads, which connect said read lines to said trace suspension assembly and multiple write line driven by preamplifierlifier circuits.

The objects of this invention are further achieved by placing the crossing point of the write lines halfway between the preamplifier connection point and the slider contact pads. In addition, the crossing point of the write line is made by the addition of a second metallization layer onto said trace suspension assembly. The crosstalk and EME minimizing structure of this invention can also use multiple crossing points of the write lines in order to further cancel out time-delayed (transmission line effects) parts of the crosstalk.

The above and other objects, features and advantages of the present invention will be better understood from the following detailed description taken in conjunction with the accompanying drawings.

### BRIEF DESCRIPTION OF THE DRAWINGS

FIG. 1 shows a prior art diagram of a typical magnetic trace suspension assembly.

FIG. 2 shows a schematic representation of adjacent Read and Write lines on a magnetic trace suspension assembly.

FIG. 3 shows the main embodiment of this invention in a schematic representation of adjacent Read and Write lines on a magnetic trace suspension assembly.

FIG. 4 shows a second embodiment of this invention in a schematic representation of adjacent Read and Write lines on a magnetic trace suspension assembly.

### DESCRIPTION OF THE PREFERRED EMBODIMENT

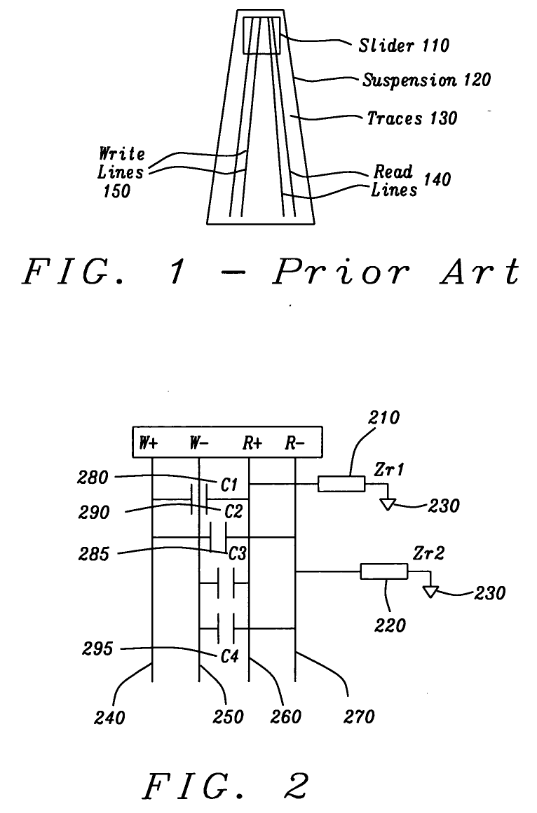

FIG. 2 shows a schematic known to the inventor. It is a representation of capacitive coupling between the write and read lines on the trace suspension assembly. This figure shows two impedances ZR1 (210) and ZR2 (220). Both of these impedances go to ground 230. These impedences ZR1 and ZR2 are a combination of trace suspension and preamplifier circuit. The other end of the ZR1 (210) impedance is connected to the Read+, R+, line 260. The other end of the ZR2 (220) impedance is connected to the Read−, R−, line 270.

FIG. 2 also shows capacitors, which represent the capacitive coupling between the Read and Write lines. Capacitor, C1 280 represents the capacitive coupling between the Write+, W+, line 240 and the Read+, R+, line 260. Capacitor, C2, 290, represents the capacitive coupling between the Write+, W+line 240 and the Read−, R−, line 270. Capacitor, C3, 285, represents the capacitive coupling between the Write−, W− line 250 and the Read+, R+line 260. Capacitor, C4, 295, represents the capacitive coupling between the Write−, W− line 250 and the Read−, R− line 270. Assuming the voltage on the write lines is W+ and W− and the impedance associated with C1, C2, C3 and C4 are Z1, Z2, Z3 and Z4 respectively. The induced voltage on R+ and R− lines can be expressed as:
VR₊=W₊(ZR1//Z3)/(Z1+ZR1//Z3)+W₋(ZR1//Z1)/(Z3+ZR1//Z1) (1a)
VR−=W₊(ZR2//Z4)/(Z2+ZR2//Z4)+W₋(ZR2//Z2)/(Z4+ZR2//Z2) (2a)
where ‘//’ signifies resistors in parallel
For the case where ZR1 and ZR2<<Z1, Z2, Z3 and Z4, this induced voltage can be expressed as:
VR₊=W₊ZR1/(Z1+ZR1)+W₋ZR1/(Z3+ZR1) (1b)
VR₋=W₊ZR2/(Z2+ZR2)+W₋ZR2/(Z4+ZR2) (2b)

Assuming ZR1˜ZR2=ZR and is small compared to Z1, Z2, Z3 and Z4, the signal pickup becomes:
VR₊−VR₋=jw(W₊ZR1*C1W₊ZR2*C2+W₋ZR*C3−W₋ZR2*C4)
jw(W₊ZR*C1−W₊ZR*C2+W₋ZR*C3−W₋ZR*C4) (3a)
where w is the angular frequency of the crosstalk.

Assuming that C3 is larger than C1 and C4 which are larger than C2 due to proximity and also assuming that W+˜=−W−
VR₊−VR₋=jw(W₊ZR1*C1−W₊ZR1*C3+W₊ZR1*C1)=W₊jw(2C1-C3) (3b)

Where w is the angular frequency of the cross talk. This differential voltage induces a current across the MR head proportional to 1/MRR where MRR is the resistance of the head.

This induced current across the MR (memory read) head becomes more of a problem as the frequency, w increases. In addition, this induced current across the MR (Memory Read) head becomes more of a problem as the values of C1 increases. In general, the values of coupling capacitance increase if the spacing of the write and read lines decreases.

FIG. 3 shows a schematic of the main embodiment of this invention. One way to overcome the problem of induced voltage on the magnetic Read lines R+, R−, is to cross the R+ 370 and R− 360 lines halfway 325 in the suspension such that all the crosstalks equally add to the R+ and R− lines canceling out the total effect. This assumes that transmission line effects are disregarded.

FIG. 3 shows two impedances ZR1 (310) and ZR2 (320). Both of these impedances go to ground 330. These impedences ZR1 and ZR2 are a combination of trace suspension and preamplifier circuit. The other end of the ZR1 (310) impedance is connected to the Read+, R+, line 370. The other end of the ZR2 (320) impedance is connected to the Read−, R−, line 360.

FIG. 3 also shows capacitors which represent the capacitive coupling between the Read and Write lines. Capacitor, C1 380 represents the capacitive coupling between the Write+, W+line 340 and the Read+, R+, line 370. Capacitor, C2, 390, represents the capacitive coupling between the Write+, W+line 340 and the Read−, R− line 360. Capacitor C3, 385, represents the capacitive coupling between the Write−, W— line 350 and the Read+, R+line 370. Capacitor C4, 385 represents the capacitive coupling between the Write−, W− line 350 and the Read−, R− line 360.

As mentioned above, one way to overcome this problem is to cross the R+ and R− lines halfway in the suspension such that all the cross talks equally add to the R+ and R− lines canceling out the total effect disregarding any transmission line effects. Note that E1, E2, E3, and E4 as well as D1, D2, D3 and D4 have half the values of C1, C2, C3 and C4.

The above equation (3b) now becomes:
VR₊−VR₋=jw(W₊ZR*E1−W+ZR*E2+W−ZR*E3−W−ZR*E4)
−jw(W₊ZR*D1−W₊ZR*D2+W−ZR*D3−W−ZR*D4)

The above equation assumes no transmission line effects and also assumes perfect matching of D1, D2, D3 and D4 with E1, E2, E3 and E4.

Such a structure would be made by the addition of second metallization layer onto the TSA to allow the crossover within the TSA structure. Alternatively crossing the write traces will also accomplish the same goal especially when W₊=−W₋. In the case of non-differential write drivers only read head crossover would reduce the cross talk. Alternatively there could also be multiple crosses of the read or write elements to further cancel out the time-delayed parts of the cross talk (transmission line effects).

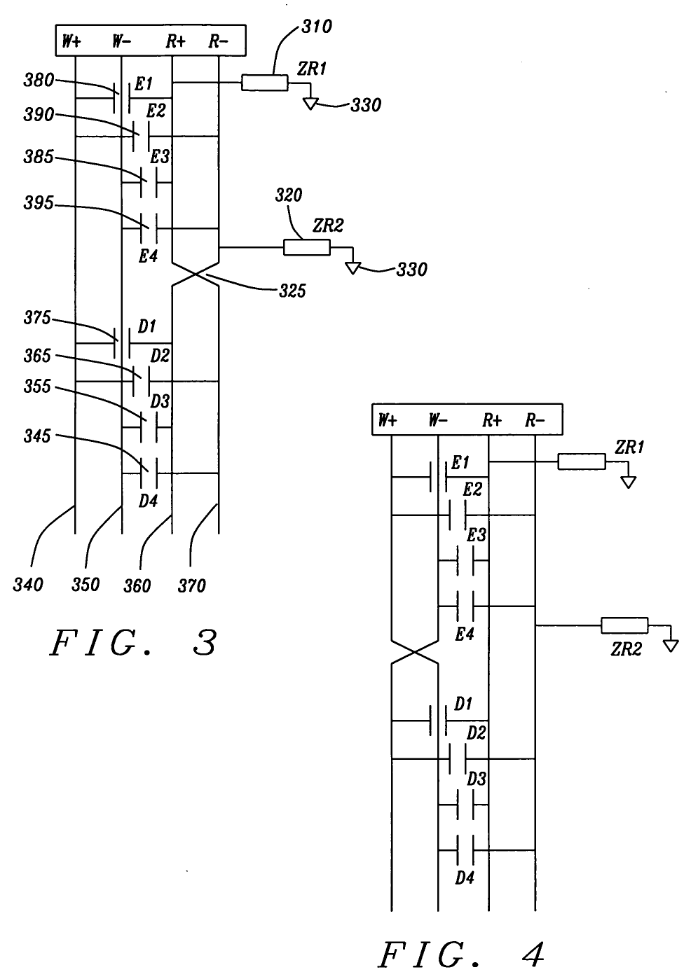

Referring to FIG. 4, crossing over the write lines would only be beneficial if W₊ and W₋ lines are approximately 180 degrees out of phase (W₊˜=−W₋). In this case, the capacitive crosstalk introduced by each write line would be cancelled out in the second part of the suspension as the line that replaces the first at the same location carries an out of phase signal. This can be mathematically expressed as follows:
VR₊−VR₋=jw(W₊ZR*E1−W₊ZR*E2+W−ZR*E3−W−ZR*E4)
−jw(W−ZR*D1−W−ZR*D2+W₊ZR*D3−W₊ZR*D4)
The only way to make VR₊−VR equal zero is to have W₊=−W−.

The advantage of this invention includes the simple halfway crossing of the Read lines to produce a complete cancellation of crosstalk noise. The simplicity of implementing this invention is a big advantage. The crossovers can simply be constructed with a second level of metallization on the trace suspension assembly.

The main advantage of the crosstalk noise reduction occurs with crossing the Read lines. However, with differential amplifiers, the halfway crossing of the Write lines can also eliminate crosstalk and EME noise on the Write lines, W₊ and W₋.

The benefits of this invention can also be scaled. As the frequency of operation increases, transmission line effects will increase. When this occurs, this invention provides for multiple crosses of the Read or Write lines to further cancel out the time-delayed parts of the crosstalk due to the increased transmission line effects. These multiple crossover points could occur at fractional points (¼, 2/4, ¾ or ⅛, 2/8, ⅜ etc.) between the preamplifierlifier connection and the slider contact pads.

While the invention has been described in terms of the preferred embodiments, those skilled in the art will recognize that various changes in form and details may be made without departing from the spirit and scope of the invention.

1. A crosstalk and EME minimizing trace suspension assembly structure comprising:
multiple write lines which are crossed between said preamplifier connection point and said slider contact pads;
multiple read lines driven by pre-amplifier circuits;
slider contact pads, which connect said write lines to said trace suspension assembly;
slider contact pads, which connect said read lines to said trace suspension assembly; and
multiple write line driven by preamplifierlifier circuits.

2. The crosstalk and EME minimizing structure of claim 1 wherein said crossing point of said write lines between said preamplifier connection point and said slider contact pads is placed halfway between said preamplifier connection point and said slider contact pads.

3. The crosstalk and EME minimizing structure of claim 1 wherein said crossing point of said write line is made by the addition of a second metallization layer onto said trace suspension assembly.

4. The crosstalk and EME minimizing structure of claim 1 wherein multiple crossing points of said write lines are used to further cancel out time-delayed (transmission line effects) parts of said crosstalk and EME.

5. The crosstalk and EME minimizing structure of claim 1 wherein said write lines have parasitic capacitance between the write lines and the read lines.

6. The crosstalk and EME minimizing structure of claim 5 wherein said parasitic capacitances between the write lines and read lines are used to cancel crosstalk noise between said write lines and said read lines.

7. A crosstalk and EME minimizing trace suspension assembly structure comprising:
multiple read lines which are crossed between said preamplifier connection point and said slider contact pads;
multiple read lines driven by pre-amplifier circuits;
slider contact pads, which connect said write lines to said trace suspension assembly;
slider contact pads, which connect said read lines to said trace suspension assembly; and
multiple write line driven by preamplifierlifier circuits.

8. The crosstalk and EME minimizing structure of claim 7 wherein said crossing point of said read lines between said preamplifier connection point and said slider contact pads is placed halfway between said preamplifier connection point and said slider contact pads.

9. The crosstalk and EME minimizing structure of claim 7 wherein said crossing point of said read line is made by the addition of a second metallization layer onto said trace suspension assembly.

10. The crosstalk and EME minimizing structure of claim 7 wherein multiple crossing points of said read lines are used to further cancel out time-delayed (transmission line effects) parts of said crosstalk and EME.

11. The crosstalk and EME minimizing structure of claim 7 wherein said read lines have parasitic capacitance between the read lines and the write lines.

12. The crosstalk and EME minimizing structure of claim 11 wherein said parasitic capacitances between the read lines and write lines are used to cancel crosstalk noise between said read lines and said write lines.

13. A crosstalk and EME minimizing trace suspension assembly structure comprising:
multiple write lines which are crossed between said preamplifier connection point and said slider contact pads;
multiple read lines which are crossed between said preamplifier connection point and said slider contact pads;
multiple read lines driven by pre-amplifier circuits;
slider contact pads, which connect said write lines to said trace suspension assembly;
slider contact pads, which connect said read lines to said trace suspension assembly; and
multiple write line driven by preamplifierlifier circuits.

14. The crosstalk and EME minimizing structure of claim 13 wherein said crossing point of said write and read lines between said preamplifier connection point and said slider contact pads is placed halfway between said preamplifier connection point and said slider contact pads.

15. The crosstalk and EME minimizing structure of claim 13 wherein said crossing point of said write and read lines is made by the addition of a second metallization layer onto said trace suspension assembly.

16. The crosstalk and EME minimizing structure of claim 13 wherein multiple crossing points of said write and read lines are used to further cancel out time-delayed (transmission line effects) parts of said crosstalk and EME.

17. The crosstalk and EME minimizing structure of claim 13 wherein said write and read lines have parasitic capacitance between the write lines and the read lines.

18. The crosstalk and EME minimizing structure of claim 17 wherein said parasitic capacitances between the write lines and read lines are used to cancel crosstalk noise between said write lines and said read lines.

19. A method of minimizing crosstalk and EME in a trace suspension assembly structure comprising the steps of:
providing multiple write lines which are crossed between said preamplifier connection point and said slider contact pads;
providing multiple read lines driven by pre-amplifier circuits;
providing slider contact pads, which connect said write lines to said trace suspension assembly;
providing slider contact pads, which connect said read lines to said trace suspension assembly; and
providing multiple write line driven by preamplifierlifier circuits.

20. The method of minimizing crosstalk and EME of claim 19 wherein said crossing point of said write lines between said preamplifier connection point and said slider contact pads is placed halfway between said preamplifier connection point and said slider contact pads.

21. The method of minimizing crosstalk and EME of claim 19 wherein said crossing point of said write line is made by the addition of a second metallization layer onto said trace suspension assembly.

22. The method of minimizing crosstalk and EME of claim 19 wherein multiple crossing points of said write lines are used to further cancel out time-delayed (transmission line effects) parts of said crosstalk and EME.

23. The method of minimizing crosstalk and EME of claim 19 wherein said write lines have parasitic capacitance between the write lines and the read lines.

24. The method of minimizing crosstalk EME of claim 23 wherein said parasitic capacitances between the write lines and read lines are used to cancel crosstalk noise between said write lines and said read lines.

25. A method of minimizing crosstalk and EME in a trace suspension assembly structure comprising the steps of:
providing multiple read lines which are crossed between said preamplifier connection point and said slider contact pads;
providing multiple read lines driven by pre-amplifier circuits;
providing slider contact pads, which connect said write lines to said trace suspension assembly;
providing slider contact pads, which connect said read lines to said trace suspension assembly; and
providing multiple write line driven by preamplifierlifier circuits.

26. The method of minimizing crosstalk and EME of claim 25 wherein said crossing point of said read lines between said preamplifier connection point and said slider contact pads is placed halfway between said preamplifier connection point and said slider contact pads.

27. The method of minimizing crosstalk EME of claim 25 wherein said crossing point of said read line is made by the addition of a second metallization layer onto said trace suspension assembly.

28. The method of minimizing crosstalk and EME of claim 25 wherein multiple crossing points of said read lines are used to further cancel out time-delayed (transmission line effects) parts of said crosstalk and EME.

29. The method of minimizing crosstalk and EME of claim 25 wherein said read lines have parasitic capacitance between the read lines and the write lines.

30. The method of minimizing crosstalk and EME of claim 29 wherein said parasitic capacitances between the read lines and write lines are used to cancel crosstalk noise between said read lines and said write lines.

31. A method of minimizing crosstalk and EME in a trace suspension assembly structure comprising the steps of:
providing multiple write lines which are crossed between said preamplifier connection point and said slider contact pads;
providing multiple read lines which are crossed between said preamplifier connection point and said slider contact pads;
providing multiple read lines driven by pre-amplifier circuits;
providing slider contact pads, which connect said write lines to said trace suspension assembly;
providing slider contact pads, which connect said read lines to said trace suspension assembly; and
providing multiple write line driven by preamplifierlifier circuits.

32. The method of minimizing crosstalk and EME of claim 31 wherein said crossing point of said write and read lines between said preamplifier connection point and said slider contact pads is placed halfway between said preamplifier connection point and said slider contact pads.

33. The method of minimizing crosstalk and EME of claim 31 wherein said crossing point of said write and read lines is made by the addition of a second metallization layer onto said trace suspension assembly.

34. The method of minimizing crosstalk and EME of claim 31 wherein multiple crossing points of said write and read lines are used to further cancel out time-delayed (transmission line effects) parts of said crosstalk and EME.

35. The method of minimizing crosstalk and EME of claim 31 wherein said write and read lines have parasitic capacitance between the write lines and the read lines.

36. The method of minimizing crosstalk and EME of claim 31 wherein said parasitic capacitances between the write lines and read lines are used to cancel crosstalk noise between said write lines and said read lines.
